(19) United States
(12) Patent Application Publication
(10) Pub. No.: US 2024/0289539 A1
(43) Pub. Date: Aug. 29, 2024

(54) CONTENT UPDATING METHOD AND APPARATUS, ELECTRONIC DEVICE, MEDIUM AND PROGRAM PRODUCT

(71) Applicant: Beijing Zitiao Network Technology Co., Ltd., Beijing (CN)

(72) Inventors: Guangping XIE, BEIJING (CN); Yang BIAN, BEIJING (CN); Haigeng ZHANG, BEIJING (CN)

(21) Appl. No.: 18/573,999

(22) PCT Filed: Oct. 31, 2022
(86) PCT No.: PCT/CN2022/128544

§ 371 Date: Dec. 22, 2023

(30) Foreign Application Priority Data
Nov. 4, 2021 (CN) 202111300825.1

(51) Int. Cl. G06F 40/166; G06F 3/0484

(52) U.S. Cl. CPC G06F 40/166; G06F 3/0484

(57) ABSTRACT

The present application relates to a content updating method and apparatus, an electronic device, a medium and a program product. The method comprises: in response to an editing operation for first target content of a first document, editing the first target content of the first document; and executing processing, corresponding to the editing operation, on second target content in a second document according to the editing operation, wherein the first target content and the second target content have a reference relationship.

### CROSS-REFERENCE TO RELATED APPLICATIONS

The present application is a National Stage Entry of International application No. PCT/CN2022/128544 filed on Oct. 31, 2022, which claims the priority to the Chinese Patent Application No. 202111300825.1 filed on Nov. 4, 2021, and entitled “CONTENT UPDATING METHOD AND APPARATUS, ELECTRONIC DEVICE, MEDIUM AND PROGRAM PRODUCT”, the disclosure of which is incorporated by reference herein in its entirety.

### TECHNICAL FIELD

The present application relates to the technical field of document processing, and in particular, to a content updating method and apparatus, an electronic device, a medium and a program product.

### BACKGROUND

In the case where there is same content among a plurality of different documents within an enterprise, if the same content in one document is edited, the same content in other documents also needs to be edited, which is a complicated operation.

At present, by means of reference, the editing efficiency of the document content can be improved; the reference refers to that content in a source document can be referenced by one or more reference documents. The content in the source document is edited, so that the content in the reference document can also be updated. However, the updating of the content in the reference document is inaccurate.

### SUMMARY

To solve the above technical problem or at least partially solve the above technical problem, the present application provides a content updating method and apparatus, an electronic device, a medium and a program product.

According to a first aspect of the present application, there is provided a content updating method, comprising:
in response to an editing operation for first target content of a first document, editing the first target content of the first document; and
executing processing, corresponding to the editing operation, on second target content in a second document according to the editing operation, wherein the first target content and the second target content have a reference relationship.

Optionally, the executing the processing, corresponding to the editing operation, on the second target content in the second document according to the editing operation comprises:
in response to the editing operation being a drag operation for the first target content, keeping a display state of the second target content in the second document unchanged; or
in response to the editing operation being another operation than the drag operation for the first target content, editing the second target content in the second document according to the editing operation.

Optionally, the first target content comprises at least two content blocks; and the editing the second target content in the second document according to the editing operation comprises:
in response to the editing operation being a position exchange operation for first and second content blocks in the first target content, performing position exchange on the corresponding first and second content blocks in the second target content; or
in response to the editing operation being a drag operation for a third content block in the first target content, deleting the corresponding third content block in the second target content; or
in response to the editing operation being to add a sixth content block between fourth and fifth content blocks in the first target content, adding the sixth content block between the corresponding fourth and fifth content blocks in the second target content; or
in response to the editing operation being a modification operation for the first target content, modifying corresponding content in the second target content; or
in response to the editing operation being a deletion operation for the first target content, deleting the second target content.

Optionally, target content references the second target content, and a user performing the editing operation has an editing permission for the first document,
the method further comprises:
acquiring an editing permission of the user for the second document; and
if the user has the editing permission for the second document, executing the editing the first target content of the first document.

Optionally, the first target content comprises at least two content blocks; and the editing the first target content of the first document comprises:
in response to the editing operation being a position exchange operation for first and second content blocks in the first target content, performing position exchange on the corresponding first and second content blocks in the first target content; or
in response to the editing operation being a drag operation for a third content block in the first target content, dragging the third content block in the first document from a first position to a second position; or
in response to the editing operation being a drag operation for the first target content, dragging the first target content in the first document from a third position to a fourth position; or
in response to the editing operation being to add a sixth content block between fourth and fifth content blocks in the first target content, adding the sixth content block between the corresponding fourth and fifth content blocks in the first target content; or
in response to the editing operation being a modification operation for the first target content, modifying corresponding content of the first target content; or
in response to the editing operation being a deletion operation for the first target content, deleting the first target content.

Optionally, the method further comprises:
establishing, in the second document, the reference relationship between the second target content and the first target content in the first document.

Optionally, the first target content comprises at least two content blocks, and the establishing, in the second document, the reference relationship between the second target content and the first target content in the first document comprises:
combining the corresponding at least two content blocks in the second target content into a whole content block, and establishing a reference relationship between the whole content block and the first target content.

Optionally, the establishing, in the second document, the reference relationship between the second target content and the first target content in the first document comprises:
in response to a copy operation for the first target content in the first document, copying the first target content;
in response to a paste operation in the second document, pasting the first target content to the second document to generate the second target content, and displaying a reference control; and
in response to a triggering operation for the reference control, establishing the reference relationship between the second target content and the first target content.

According to a second aspect of the present application, there is provided a content updating apparatus, comprising:
a first editing module configured to, in response to an editing operation for first target content of a first document, edit the first target content of the first document; and
a second editing module configured to execute processing, corresponding to the editing operation, on second target content in a second document according to the editing operation, wherein the first target content and the second target content have a reference relationship.

Optionally, the second editing module is specifically configured to, in response to the editing operation being a drag operation for the first target content, keep a display state of the second target content in the second document unchanged; or, in response to the editing operation being another operation than the drag operation for the first target content, edit the second target content in the second document according to the editing operation.

Optionally, the first target content comprises at least two content blocks; and the second editing module is specifically configured to, in response to the editing operation being a position exchange operation for first and second content blocks in the first target content, perform position exchange on the corresponding first and second content blocks in the second target content; or
in response to the editing operation being a drag operation for a third content block in the first target content, delete the corresponding third content block in the second target content; or
in response to the editing operation being to add a sixth content block between fourth and fifth content blocks in the first target content, add the sixth content block between the corresponding fourth and fifth content blocks in the second target content; or
in response to the editing operation being a modification operation for the first target content, modify corresponding content in the second target content; or
in response to the editing operation being a deletion operation for the first target content, delete the second target content.

Optionally, if the first target content references the second target content, and a user performing the editing operation has an editing permission for the first document,
the apparatus further comprises:
an editing permission acquisition module configured to acquire an editing permission of the user for the second document; and
the first editing module is specifically configured to, in response to the editing operation for the first target content of the first document, if it is determined that the user has the editing permission for the second document, execute the editing the first target content of the first document.

Optionally, the first target content comprises at least two content blocks; and the first editing module is specifically configured to, in response to the editing operation being a position exchange operation for first and second content blocks in the first target content, perform position exchange on the corresponding first and second content blocks in the first target content; or
in response to the editing operation being a drag operation for a third content block in the first target content, drag the third content block in the first document from a first position to a second position; or
in response to the editing operation being a drag operation for the first target content, drag the first target content in the first document from a third position to a fourth position; or
in response to the editing operation being to add a sixth content block between fourth and fifth content blocks in the first target content, add the sixth content block between the corresponding fourth and fifth content blocks in the first target content; or
in response to the editing operation being a modification operation for the first target content, modify corresponding content of the first target content; or
in response to the editing operation being a deletion operation for the first target content, delete the first target content.

Optionally, the content updating apparatus further comprises:
a reference relationship establishment module configured to establish, in the second document, the reference relationship between the second target content and the first target content in the first document.

Optionally, the first target content comprises at least two content blocks, and the reference relationship establishment module is specifically configured to combine the corresponding at least two content blocks in the second target content into a whole content block, and establish a reference relationship between the whole content block and the first target content.

Optionally, the reference relationship establishment module is specifically configured to, in response to a copy operation for the first target content in the first document, copy the first target content; in response to a paste operation in the second document, paste the first target content to the second document to generate the second target content, and display a reference control; and in response to a triggering operation for the reference control, establish the reference relationship between the second target content and the first target content.

According to a third aspect of the present application, there is provided an electronic device, comprising: a processor configured to execute a computer program stored in a memory, wherein the computer program, when executed by the processor, implements the method according to the first aspect.

According to a fourth aspect of the present application, there is provided a non-transitory computer-readable storage medium having thereon stored a computer program which, when executed by a processor, implements the method according to the first aspect.

According to a fifth aspect of the present application, there is provided a computer program product which, when running on a computer, causes the computer to perform the method according to the first aspect.

According to a sixth aspect of the present application, there is provided a computer program, comprising instructions which, when executed by a processor, cause the processor to perform the method according to the first aspect.

### BRIEF DESCRIPTION OF THE DRAWINGS

The accompanying drawings herein, which are incorporated in and constitute part of this specification, illustrate embodiments consistent with this application and together with the description, serve to explain the principles of the present application.

In order to more clearly illustrate technical solutions in the embodiments of the present application or in the related art, the drawings that need to be used in the description of the embodiments or the related art will be briefly described below, and it is obvious that, for one of ordinary skill in the art, other drawings can also be obtained according to these drawings without paying out creative efforts.

FIG. 1 is a schematic diagram of a scenario for a content updating method according to an embodiment of the present application;

FIG. 2 is a flow diagram of a content updating method according to an embodiment of the present application;

FIG. 3 is another flow diagram of a content updating method according to an embodiment of the present application;

FIG. 4 is a schematic diagram of displaying a reference setting menu according to an embodiment of the present application;

FIG. 5 is a schematic diagram of content exchange according to an embodiment of the present application;

FIG. 6 is a schematic diagram of content addition according to an embodiment of the present application;

FIG. 7 is a schematic structural diagram of a content updating apparatus according to an embodiment of the present application;

FIG. 8 is a schematic structural diagram of an electronic device according to an embodiment of the present application.

### DETAILED DESCRIPTION

In order that the above objectives, features and advantages of the present application can be more clearly understood, the solutions of the present application will be further described below. It should be noted that the embodiments of the present application and the features in the embodiments may be combined with each other without conflicts.

In the following description, numerous specific details are set forth in order to provide a thorough understanding of the present application, but the present application can also be implemented in other ways than those described herein; and it is obvious that the embodiments described in this description are only some embodiments of the present application, and not all embodiments.

Compared with the related art, the technical solutions provided by the embodiments of the present application have the following advantages:
when an editing operation is performed on first target content in a first document, editing the first target content in the first document. Meanwhile, since the first target content and second has a target content reference relationship, processing corresponding to the editing operation can be executed on the second target content in a second document based on the editing operation. That is, different processing may be executed on the second target content in the second document based on different editing operations, which avoids misidentification of the editing operation, and improves the accuracy of synchronous updating of the target content in the second document.

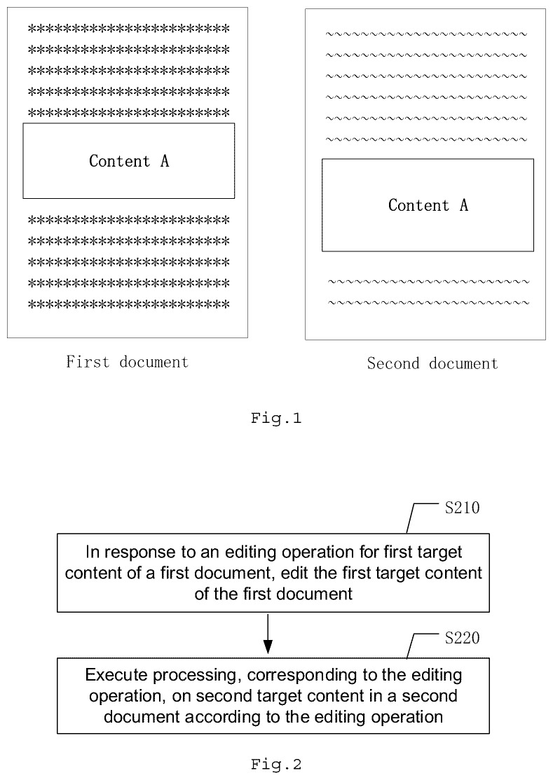

FIG. 1 is a schematic diagram of a scenario for a content updating method according to an embodiment of the present application. As shown in FIG. 1, a first document and a second document contain same content A, and the content A in the first document is copied to the second document, so that the content A can be obtained, that is, the content A in the second document is referenced from the first document. A user may perform an editing operation on the content A in the first document, and accordingly, the content A in the second document will be also updated synchronously. Conversely, the user performs an editing operation on the content A in the second document, and the content A in the first document will be also updated synchronously.

For example, if a drag operation is performed on the content A in the first document, an actual intention of the user might be to merely adjust an order of the content A in the first document, rather than deleting the content A, and thus, a display state of the content A in the second document may be kept unchanged. If a deletion operation is performed on the content A in the first document, the content A in the second document may be deleted, and so on.

The content updating method according to the embodiments of the present application will be described in detail below.

Reference is made to FIG. 2, which is a flow diagram of a content updating method according to an embodiment of the present application, and the method may comprise the following steps:

Step S210, in response to an editing operation for first target content of a first document, editing the first target content of the first document.

The first target content in the first document is content having a reference relationship with content in another document (e.g., the second document hereinafter). For example, the first target content may be content referenced by another document, or may be content referenced from another document. The editing operation for the first target content in the first document may include: drag, modification, deletion, cut, or the like. Based on the editing operation, editing processing may be performed on the first target content in the first document.

Step S220, executing processing, corresponding to the editing operation, on second target content in a second document according to the editing operation.

In the embodiment of the present application, the second target content in the second document and the first target content have a reference relationship, so that the second target content is the same as the first target content. The number of the second document may be one or more. The second target content in the second document and the first target content in the first document may have a direct or indirect reference relationship. For example, target content in a document 1 is directly referenced by a document 2, and target content in the document 2 is further referenced by a document 3, then, in the case where the document 1 is a first document, both the document 2 and the document 3 may be a second document.

According to the present application, the editing operation may be classified, so that for different editing operations, the processing executed on the second target content in the second document may be different. In this way, the processing corresponding to the editing operation is executed on the second target content in the second document according to the editing operation, which can accurately identify an editing intention of a user, and improves the accuracy of updating the second target content in the second document.

Optionally, if the first target content references the second target content and the user performing the editing operation has an editing permission for the first document, an editing permission of the user for the second document is acquired in response to the editing operation for the first target content of the first document. If the user has the editing permission for the second document, the step of editing the first target content of the first document is executed. In this way, in the case where the user has the editing permission for the first document but does not have the editing permission for the second document, the user cannot modify the first target content in the first document that references the second target content either. Further, the second target content in the second document cannot be updated synchronously either, which avoids the user without the editing permission from performing the editing operation on the document, and improves the security of the document editing.

According to the content updating method of the embodiment of the present application, when an editing operation is performed on the first target content in the first document, the first target content in the first document is edited. Meanwhile, since the first target content and the second target content have a reference relationship, processing corresponding to the editing operation can be executed on the second target content in the second document based on the editing operation. That is, different processing may be executed on the second target content in the second document based on different editing operations, which avoids misidentification of the editing operation, and improves the accuracy of synchronous updating of the target content in the second document.

Hereinafter, by taking an example that the second target content references the first target content, the content updating method of the embodiment of the present application is described.

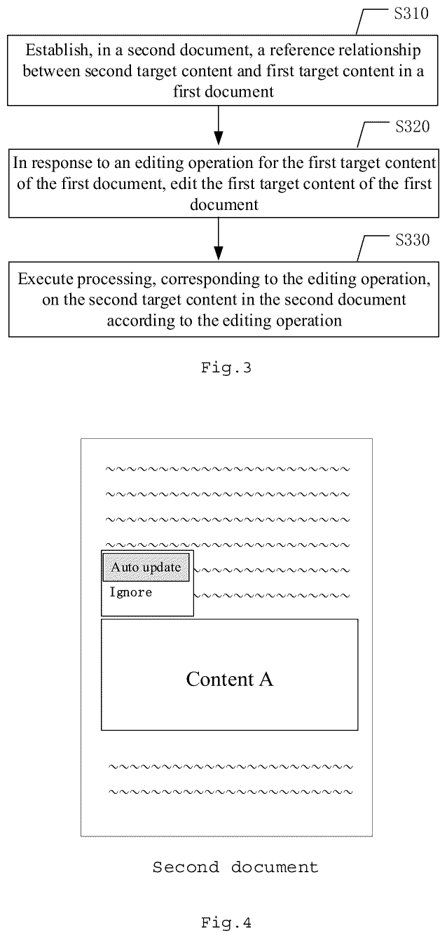

Reference is made to FIG. 3, which is another flow diagram of a content updating method according to an embodiment of the present application, and the method may comprise the following steps:

Step S310, establishing, in a second document, a reference relationship between second target content and first target content in a first document.

Assuming that the second document intends to reference the first target content in the first document, the reference relationship between the second target content and the first target content in the first document may be established in the second document. The reference relationship between the first target content in the first document and the second target content in the second document can be established in a manner of copying and pasting.

In an optional implementation, the first target content is copied in response to a copy operation for the first target content in the first document. Then, a user may select a position to paste and perform a paste operation in the second document. In response to the paste operation in the second document, the first target content is pasted to the second document to generate the second target content, and a reference control is displayed. The reference control is used for establishing the reference relationship, and after the reference relationship is established, the second target content in the second document is automatically updated when the first target content in the first document is edited.

In response to a triggering operation for the reference control, the reference relationship between the second target content and the first target content is established. In this way, in the case of performing editing processing on the first target content in the first document, the corresponding editing processing is automatically performed on the second target content in the second document.

Reference is made to FIG. 4, which is a schematic diagram of displaying a reference setting menu according to an embodiment of the present application, based on the reference of the content A shown in FIG. 1. After the content A is pasted in the second document, the reference setting menu is displayed. The reference setting menu includes an “auto update” control and an “ignore” control, wherein the “auto update” control is the reference control. If the “ignore” control is selected by the user, it shows that the reference relationship is not established, and if the “auto update” control is selected by the user, it shows that the reference relationship is established.

A content block is a basic editing unit of the document, wherein each document can contain one or more content blocks which are independent from one another. Optionally, if the first target content comprises at least two content blocks, the corresponding at least two content blocks in the second target content may be combined into a whole content block, and a reference relationship between the whole content block and the first target content is established. That is, if the first target content and the second target content have reference relationships for a plurality of content blocks, the reference relationships for the plurality of content blocks can be combined into a reference relationship for one whole content block, to simplify the document processing and improve the efficiency of the document processing.

Step S320, in response to an editing operation for the first target content of the first document, editing the first target content of the first document.

It can be understood that, no matter whether or not the reference relationship is established, the first target content in the first document can be edited by performing the editing operation on the first target content in the first document. In the case of the reference relationship is established, step S330 may be further executed.

In the case where the first target content comprises at least two content blocks, according to the present application, positions of the content blocks in the first target content of the first document may be exchanged. In response to the editing operation being a position exchange operation for first and second content blocks in the first target content, position exchange on the corresponding first and second content blocks in the first target content is performed. The first content block and the second content block are two different content blocks in the first target content.

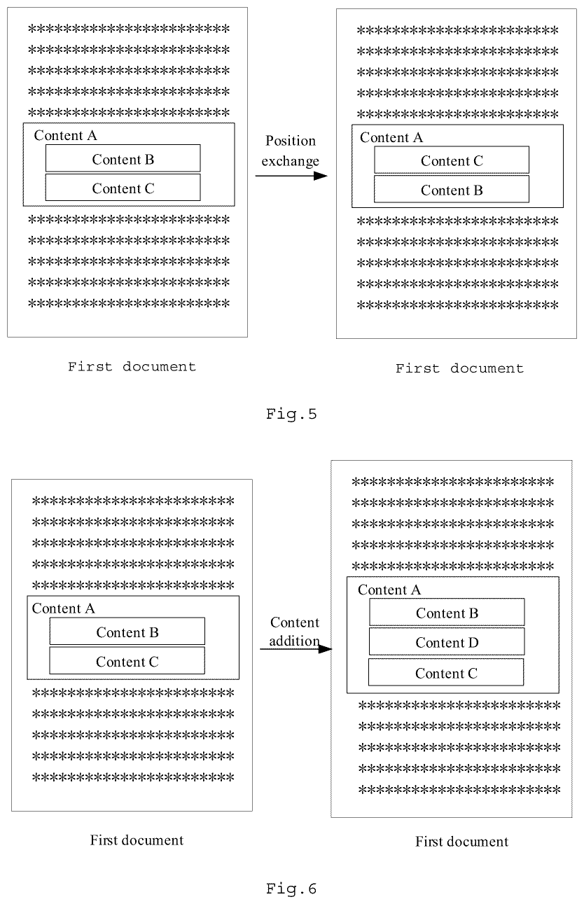

Reference is made to FIG. 5, which is a schematic diagram of content exchange according to an embodiment of the present application, from which it can be seen that the first target content is content A, including: content B and content C, which correspond to the first content block and the second content block, respectively; an exchange operation may be performed on the first and second content blocks to exchange positions of the content B and the content C.

According to the present application, part of the first target content in the first document may be dragged, or the first target content may be dragged wholly. In response to the editing operation being a drag operation for a third content block in the first target content, the third content block in the first document is dragged from a first position to a second position; and in response to the editing operation being a drag operation for the first target content, the first target content in the first document is dragged from a third position to a fourth position. It can be seen that, when the part of the first target content is dragged and the first target content is dragged wholly, the corresponding editing processing modes in the first document are the same, both moving the position of the dragged content.

According to the present application, it is also possible to add new content in the first target content. In response to the editing operation being to add a sixth content block between fourth and fifth content blocks in the first target content, the sixth content block is added between the corresponding fourth and fifth content blocks in the first target content. The added content may be original content in the first document, or content acquired from another document, or the like. Reference is made to FIG. 6, which is a schematic diagram of content addition according to an embodiment of the present application, from which it can be seen that content D is added between the content B and content C.

In addition, in response to the editing operation being a modification operation for the first target content, corresponding content of the first target content is modified; and in response to the editing operation being a deletion operation for the first target content, the first target content is deleted.

Step S330, executing processing, corresponding to the editing operation, on the second target content in the second document according to the editing operation, wherein the first target content and the second target content have the reference relationship.

In the embodiment of the present application, the editing operation can be classified into two major categories: a drag operation for the first target content and another operation than the drag operation for the first target content. If the editing operation is the drag operation for the first target content, it may be determined that the actual intention of the user is to adjust an order of the first target content in the first document, rather than deleting the first target content. In response to the editing operation being the drag operation for the first target content, a display state of the second target content in the second document is kept unchanged, that is, the second target content in the second document is not deleted. In this way, it can be avoided that the user just adjusts the first target content of the first document, but the second target content in real-time reference in the second document is deleted, so that the accuracy of the content updating in the second document is improved.

If the editing operation is another operation than the drag operation for the first target content, in response to the editing operation being the another operation than the drag operation for the first target content, the second target content in the second document is edited according to the editing operation.

Similarly to the foregoing editing processing for the first document, in response to the editing operation being a position exchange operation for first and second content blocks in the first target content, position exchange on the corresponding first and second content blocks in the second target content is performed; or, in response to the editing operation being to add a sixth content block between fourth and fifth content blocks in the first target content, the sixth content block is added between the corresponding fourth and fifth content blocks in the second target content; or, in response to the editing operation being a modification operation for the first target content, corresponding content in the second target content is modified; or, in response to the editing operation being a deletion operation for the first target content, the second target content is deleted. For the above editing processing, reference is made to the editing processing for the first document in the step S320, which it is not repeated herein.

It should be noted that, in response to the editing operation being a drag operation for a third content block in the first target content, the corresponding third content block in the second target content is deleted. It can be seen that the editing processing mode is different from the foregoing editing processing mode for the first document. If the editing operation is a drag operation for part of the first target content, rather than the whole content, it may be determined that the actual intention of the user is to adjust the first target content in the first document that is referenced by another document, so that the third content block is not referenced by the another document. Therefore, the third content block in the second document can be deleted according to the drag operation for the third content block in the first target content.

According to the content updating method of the embodiment of the present application, when the user pastes the first target content in the first document to the second document, a reference relationship can be established. In this way, when the user edits the first target content in the first document, the second target content in the second document can also be updated synchronously. Moreover, specifically, the second target content in the second document may be processed based on an editing operation for the first target content in the first document. For example, if the editing operation is a drag operation for the first target content, it may be determined that an actual intention of the user is to adjust an order of the first target content in the first document, rather than deleting the first target content, so that a display state of the second target content in the second document may be kept unchanged. If the editing operation is another operation, the second target content in the second document is edited according to the editing operation. According to the present application, the misidentification of the editing operation is avoided, and the accuracy of updating of the second target content in the second document is improved. Similarly, when an editing operation is performed on the second target content in the second document, the first target content in the first document may also be processed based on the editing operation, so that the accuracy of updating of the first target content in the first document is improved.

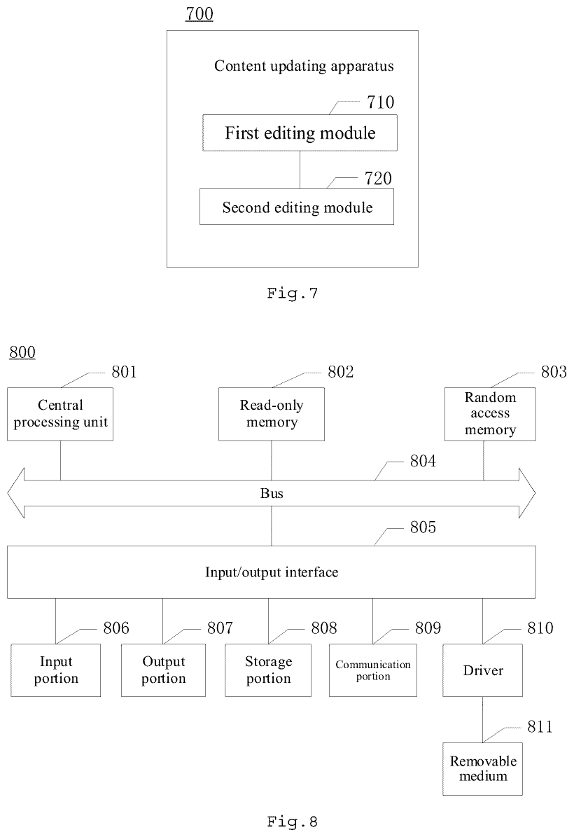

Corresponding to the foregoing method embodiment, an embodiment of the present application further provides a content updating apparatus, by referring to FIG. 7, the content updating apparatus 700 comprising:
a first editing module 710 configured to, in response to an editing operation for first target content of a first document, edit the first target content of the first document; and
a second editing module 720 configured to execute processing, corresponding to the editing operation, on second target content in a second document according to the editing operation; wherein the first target content and the second target content have a reference relationship.

Optionally, the second editing module 720 is specifically configured to, in response to the editing operation being a drag operation for the first target content, keep a display state of the second target content in the second document unchanged; or, in response to the editing operation being another operation than the drag operation on the first target content, edit the second target content in the second document according to the editing operation.

Optionally, the first target content comprises at least two content blocks; and the second editing module 720 is specifically configured to, in response to the editing operation being a position exchange operation for first and second content blocks in the first target content, perform position exchange on the corresponding first and second content blocks in the second target content; or
in response to the editing operation being a drag operation for a third content block in the first target content, delete the corresponding third content block in the second target content; or
in response to the editing operation being to add a sixth content block between fourth and fifth content blocks in the first target content, add the sixth content block between the corresponding fourth and fifth content blocks in the second target content; or
in response to the editing operation being a modification operation for the first target content, modify corresponding content in the second target content; or
in response to the editing operation being a deletion operation for the first target content, delete the second target content.

Optionally, if the first target content references the second target content, and a user performing the editing operation has an editing permission for the first document,
the content updating apparatus 700 further comprises:
an editing permission acquisition module configured to acquire an editing permission of the user for the second document; and
the first editing module 710 is specifically configured to, in response to the editing operation for the first target content of the first document, if it is determined that the user has the editing permission for the second document, execute the editing the first target content of the first document.

Optionally, the first target content comprises at least two content blocks; and the first editing module 710 is specifically configured to, in response to the editing operation being a position exchange operation for first and second content blocks in the first target content, perform position exchange on the corresponding first and second content blocks in the first target content; or
in response to the editing operation being a drag operation for a third content block in the first target content, drag the third content block in the first document from a first position to a second position; or
in response to the editing operation being a drag operation for the first target content, drag the first target content in the first document from a third position to a fourth position; or in response to the editing operation being to add a sixth content block between fourth and fifth content blocks in the first target content, add the sixth content block between the corresponding fourth and fifth content blocks in the first target content; or
in response to the editing operation being a modification operation for the first target content, modify corresponding content of the first target content; or
in response to the editing operation being a deletion operation for the first target content, deleting the first target content.

Optionally, the content updating apparatus 700 further comprises:
a reference relationship establishment module configured to establish, in the second document, the reference relationship between the second target content and the first target content in the first document.

Optionally, the first target content comprises at least two content blocks, and the reference relationship establishment module is specifically configured to combine the corresponding at least two content blocks in the second target content into a whole content block, and establish a reference relationship between the whole content block and the first target content.

Optionally, the reference relationship establishment module is specifically configured to, in response to a copy operation for the first target content in the first document, copy the first target content; in response to a paste operation in the second document, paste the first target content to the second document to generate the second target content, and display a reference control; and in response to a triggering operation for the reference control, establish the reference relationship between the second target content and the first target content.

The specific details of each module or unit in the above apparatus have been described in detail in the corresponding method, and thus are not repeated herein.

It should be noted that although several modules or units of the apparatus for action execution are mentioned in the above detailed description, such a division is not mandatory. In fact, features and functions of two or more modules or units described above may be embodied in one module or unit according to the implementations of the present application. Conversely, features and functions of one module or unit described above may be further divided into a plurality of modules or units for embodiment.

In an exemplary embodiment of the present application, there is further provided an electronic device, comprising: a processor; and a memory for storing instructions executable by the processor, the processor being configured to perform the content updating method described above in the present exemplary implementation.

FIG. 8 is a schematic structural diagram of an electronic device according to an embodiment of the present application. It should be noted that the electronic device 800 shown in FIG. 8 is only an example, and should not bring any limitation to the functions and the scope of use of the embodiment of the present application.

As shown in FIG. 8, the electronic device 800 includes a central processing unit (CPU) 801 that can perform various appropriate actions and processes according to a program stored in a read-only memory (ROM) 802 or a program loaded from a storage portion 808 into a random access memory (RAM) 803. In the RAM 803, various programs and data necessary for system operation are also stored. The central processing unit 801, ROM 802, and RAM 803 are connected to each other by a bus 804. An input/output (I/O) interface 805 is also connected to the bus 804.

The following components are connected to the I/O interface 805: an input portion 806 including a keyboard, a mouse, and the like; an output portion 807 including a cathode ray tube (CRT), a liquid crystal display (LCD), and the like, and a speaker, and the like; the storage portion 808 including a hard disk and the like; and a communication portion 809 including a network interface card such as a local area network (LAN) card, a modem, and the like. The communication portion 809 performs communication processing via a network such as the Internet. A driver 810 is also connected to the I/O interface 805 as needed. A removable medium 811 such as a magnetic disk, an optical disk, a magneto-optical disk, and a semiconductor memory, is mounted on the driver 810 as needed, so that the computer program read out therefrom is installed into the storage portion 808 as needed.

In particular, the processes described above with reference to the flow diagrams may be implemented as a computer software program according to an embodiment of the present application. For example, an embodiment of the present application comprises a computer program product, which comprises a computer program carried on a computer-readable medium, the computer program containing program code for performing the method illustrated by the flow diagram. In such an embodiment, the computer program may be downloaded from a network through the communication portion 809 and installed and/or installed from the removable medium 811. When the computer program is executed by the central processing unit 801, various functions defined in the apparatus of the present application are executed.

In an embodiment of the present application, there is further provided a non-transitory computer-readable storage medium having thereon stored a computer program which, when executed by a processor, implements the content updating method described above.

It should be noted that the computer-readable storage medium shown in the present application can be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer diskette, a hard disk, a random access memory, a read-only memory, an erasable programmable read-only memory (EPROM or flash memory), an optical fiber, a portable compact disc read-only memory (CD-ROM), an optical storage device, a magnetic storage device, or any suitable combination of the foregoing. In the present application, the computer-readable storage medium may be any tangible medium containing or storing a program, wherein the program can be used by or in conjunction with an instruction execution system, apparatus, or device. Program code contained on the computer-readable storage medium may be transmitted using any appropriate medium, including but not limited to: a wireless, wire, fiber optic cable, radio frequency, etc., or any suitable combination of the foregoing.

In an embodiment of the present application, there is further provided a computer program product which, when running on a computer, causes the computer to perform the content updating method described above.

In an embodiment of the present application, there is further provided a computer program, comprising instructions which, when executed by a processor, cause the processor to perform the content updating method.

It should be noted that, relational terms such as “first” and “second”, herein, are only used for distinguishing one entity or operation from another entity or operation without necessarily requiring or implying any such actual relation or order between these entities or operations. Moreover, the term “include”, “comprise”, or any other variation thereof, is intended to encompass a non-exclusive inclusion, such that a process, method, article, or device including a list of elements includes not only those elements but also other elements not expressly listed, or elements inherent to such a process, method, article, or device. Without more limitations, an element defined by a statement “including one . . . ” does not exclude the presence of another identical element in the process, method, article, or device that includes the element.

The above only describes specific implementations of the present application, which enable those skilled in the art to understand or implement the present application. Various modifications to these embodiments will be apparent to those skilled in the art, and the general principles defined herein may be implemented in other embodiments without departing from the spirit or scope of the present application. Therefore, the present application will not be limited to these embodiments described herein, but conform to the widest scope consistent with the principles and novel features disclosed herein.

1. A content updating method, comprising:
in response to an editing operation for first target content of a first document, editing the first target content of the first document; and
executing processing, corresponding to the editing operation, on second target content in a second document according to the editing operation, wherein the first target content and the second target content have a reference relationship.

2. The method according to claim 1, wherein the executing the processing, corresponding to the editing operation, on the second target content in the second document according to the editing operation comprises:
in response to the editing operation being a drag operation for the first target content, keeping a display state of the second target content in the second document unchanged; or
in response to the editing operation being another operation than the drag operation for the first target content, editing the second target content in the second document according to the editing operation.

3. The method according to claim 2, wherein the first target content comprises at least two content blocks; and the editing the second target content in the second document according to the editing operation comprises:
in response to the editing operation being a position exchange operation for first and second content blocks in the first target content, performing position exchange on the corresponding first and second content blocks in the second target content; or
in response to the editing operation being a drag operation for a third content block in the first target content, deleting the corresponding third content block in the second target content; or
in response to the editing operation being to add a sixth content block between fourth and fifth content blocks in the first target content, adding the sixth content block between the corresponding fourth and fifth content blocks in the second target content; or
in response to the editing operation being a modification operation for the first target content, modifying corresponding content in the second target content; or
in response to the editing operation being a deletion operation for the first target content, deleting the second target content.

4. The method according to claim 1, wherein if the first target content references the second target content, and a user performing the editing operation has an editing permission for the first document,
the method further comprises:
acquiring an editing permission of the user for the second document; and
if the user has the editing permission for the second document, executing the editing the first target content of the first document.

5. The method according to claim 1, wherein the first target content comprises at least two content blocks; and the editing the first target content of the first document comprises:
in response to the editing operation being a position exchange operation for first and second content blocks in the first target content, performing position exchange on the corresponding first and second content blocks in the first target content; or
in response to the editing operation being a drag operation for a third content block in the first target content, dragging the third content block in the first document from a first position to a second position; or
in response to the editing operation being a drag operation for the first target content, dragging the first target content in the first document from a third position to a fourth position; or
in response to the editing operation being to add a sixth content block between fourth and fifth content blocks in the first target content, adding the sixth content block between the corresponding fourth and fifth content blocks in the first target content; or
in response to the editing operation being a modification operation for the first target content, modifying corresponding content of the first target content; or
in response to the editing operation being a deletion operation for the first target content, deleting the first target content.

6. The method according to claim 1, wherein the method further comprises:
establishing, in the second document, the reference relationship between the second target content and the first target content in the first document.

7. The method according to claim 6, wherein the first target content comprises at least two content blocks, and the establishing, in the second document, the reference relationship between the second target content and the first target content in the first document comprises:
combining the corresponding at least two content blocks in the second target content into a whole content block, and establishing a reference relationship between the whole content block and the first target content.

8. The method according to claim 6, wherein the establishing, in the second document, the reference relationship between the second target content and the first target content in the first document comprises:
in response to a copy operation for the first target content in the first document, copying the first target content;
in response to a paste operation in the second document, pasting the first target content to the second document to generate the second target content, and displaying a reference control; and
in response to a triggering operation for the reference control, establishing the reference relationship between the second target content and the first target content.

9. (canceled)

10. An electronic device, comprising: a memory; and a processor configured to execute a computer program stored in the memory, wherein the computer program, when executed by the processor, implements the steps of;
in response to an editing operation for first target content of a first document, editing the first target content of the first document; and
executing processing, corresponding to the editing operation, on second target content in a second document according to the editing operation, wherein the first target content and the second target content have a reference relationship.

11. A non-transitory computer-readable storage medium having thereon stored a computer program which, when executed by a processor, implements the steps of;
in response to an editing operation for first target content of a first document, editing the first target content of the first document; and
executing processing, corresponding to the editing operation, on second target content in a second document according to the editing operation, wherein the first target content and the second target content have a reference relationship.

12. (canceled)

13. (canceled)

14. The electronic device according to claim 10, wherein the step of executing the processing, corresponding to the editing operation, on the second target content in the second document according to the editing operation comprises:
in response to the editing operation being a drag operation for the first target content, keeping a display state of the second target content in the second document unchanged; or
in response to the editing operation being another operation than the drag operation for the first target content, editing the second target content in the second document according to the editing operation.

15. The electronic device according to claim 14, wherein the first target content comprises at least two content blocks; and the step of editing the second target content in the second document according to the editing operation comprises:
in response to the editing operation being a position exchange operation for first and second content blocks in the first target content, performing position exchange on the corresponding first and second content blocks in the second target content; or
in response to the editing operation being a drag operation for a third content block in the first target content, deleting the corresponding third content block in the second target content; or
in response to the editing operation being to add a sixth content block between fourth and fifth content blocks in the first target content, adding the sixth content block between the corresponding fourth and fifth content blocks in the second target content; or
in response to the editing operation being a modification operation for the first target content, modifying corresponding content in the second target content; or
in response to the editing operation being a deletion operation for the first target content, deleting the second target content.

16. The electronic device according to claim 10, wherein if the first target content references the second target content, and a user performing the editing operation has an editing permission for the first document,
wherein the computer program, when executed by the processor, further implements the steps of:
acquiring an editing permission of the user for the second document; and
if the user has the editing permission for the second document, executing the editing the first target content of the first document.

17. The electronic device according to claim 10, wherein the first target content comprises at least two content blocks; and the step of editing the first target content of the first document comprises:
in response to the editing operation being a position exchange operation for first and second content blocks in the first target content, performing position exchange on the corresponding first and second content blocks in the first target content; or
in response to the editing operation being a drag operation for a third content block in the first target content, dragging the third content block in the first document from a first position to a second position; or
in response to the editing operation being a drag operation for the first target content, dragging the first target content in the first document from a third position to a fourth position; or
in response to the editing operation being to add a sixth content block between fourth and fifth content blocks in the first target content, adding the sixth content block between the corresponding fourth and fifth content blocks in the first target content; or
in response to the editing operation being a modification operation for the first target content, modifying corresponding content of the first target content; or
in response to the editing operation being a deletion operation for the first target content, deleting the first target content.

18. The electronic device according to claim 10, wherein the computer program, when executed by the processor, further implements the steps of:
establishing, in the second document, the reference relationship between the second target content and the first target content in the first document.

19. The electronic device according to claim 18, wherein the first target content comprises at least two content blocks, and the step of establishing, in the second document, the reference relationship between the second target content and the first target content in the first document comprises:
combining the corresponding at least two content blocks in the second target content into a whole content block, and establishing a reference relationship between the whole content block and the first target content.

20. The electronic device according to claim 18, wherein the step of establishing, in the second document, the reference relationship between the second target content and the first target content in the first document comprises:
in response to a copy operation for the first target content in the first document, copying the first target content;
in response to a paste operation in the second document, pasting the first target content to the second document to generate the second target content, and displaying a reference control; and
in response to a triggering operation for the reference control, establishing the reference relationship between the second target content and the first target content.

21. The non-transitory computer-readable storage medium according to claim 11, wherein the step of executing the processing, corresponding to the editing operation, on the second target content in the second document according to the editing operation comprises:
in response to the editing operation being a drag operation for the first target content, keeping a display state of the second target content in the second document unchanged; or
in response to the editing operation being another operation than the drag operation for the first target content, editing the second target content in the second document according to the editing operation.

22. The non-transitory computer-readable storage medium according to claim 21, wherein the first target content comprises at least two content blocks; and the step of editing the second target content in the second document according to the editing operation comprises:
in response to the editing operation being a position exchange operation for first and second content blocks in the first target content, performing position exchange on the corresponding first and second content blocks in the second target content; or
in response to the editing operation being a drag operation for a third content block in the first target content, deleting the corresponding third content block in the second target content; or
in response to the editing operation being to add a sixth content block between fourth and fifth content blocks in the first target content, adding the sixth content block between the corresponding fourth and fifth content blocks in the second target content; or
in response to the editing operation being a modification operation for the first target content, modifying corresponding content in the second target content; or
in response to the editing operation being a deletion operation for the first target content, deleting the second target content.

23. The non-transitory computer-readable storage medium according to claim 11, wherein if the first target content references the second target content, and a user performing the editing operation has an editing permission for the first document,
Wherein the computer program which, when executed by a processor, further implements the steps of:
acquiring an editing permission of the user for the second document; and
if the user has the editing permission for the second document, executing the editing the first target content of the first document.
